(19) United States
(12) Patent Application Publication
(10) Pub. No.: US 2008/0131590 A1
(43) Pub. Date: Jun. 5, 2008

(54) METHOD FOR PRINTING ELECTRICALLY CONDUCTIVE CIRCUITS

(75) Inventors: Stephen F. Drews, Williamsburg, MI (US); Richard A. Padilla, Queen Creek, AZ (US)

Correspondence Address: Levenfeld Pearlstein, LLC (ILLINOIS TOOL WORKS), 2 North LaSalle Street, Suite 1300, Chicago, IL, 60602, US

(73) Assignee: ILLINOIS TOOL WORKS INC., Glenview, IL (US)

(21) Appl. No.: 11/944,973

(22) Filed: Nov. 26, 2007

Related U.S. Application Data
(60) Provisional application No. 60/868,403, filed on Dec. 4, 2006.

(51) Int. Cl. B05D 5/12

(52) U.S. Cl. 427/97.3

(57) ABSTRACT

A method for printing electrically conductive circuits is disclosed. The method comprises the steps of providing a substrate, printing a circuit design on the substrate, providing a film having a conductive layer, selectively transferring portions of the conductive layer of the film to the printed circuit design on the substrate, optionally removing any remaining release coat and optionally applying a protective overcoat. The method of the present invention is particularly useful for creating flexible circuits.

### BACKGROUND OF THE INVENTION

The present invention is directed to a method for printing electrically conductive circuits. More particularly, the present invention is directed to a method for printing circuit designs on a substrate and selectively transferring portions of a conductive layer of a film to the printed circuit designs using a hot lamination process. The method of the present invention is particularly useful for creating flexible circuits.

There are many known processes for fabricating circuitry. One such process that is particularly useful in the fabrication of flexible or bendable circuitry is a silkscreen method. Such circuitry is found in, for example, automobile dashboards, appliance control panels, aircraft backlit panels, computers and the like. The circuitry is printed on a flexible substrate such as a polyester film.

The silkscreen process, however, can be quite complex. First, a screen is fabricated to meet the particular, desired circuit by producing a photographic negative of the circuit. A frame is made and silk is stretched over the frame. A photo resist (negative) is applied to the silk, and the screen is exposed to the negative. The screen is then developed to produce a “picture” of the circuit on the screen.

A panel is then fabricated by using a substrate that can accept the screen print inks, such as polyester, and mixing and applying conductive inks. Typically, the inks are applied in layers. After the ink is applied, the screen is cured to harden or dry the ink on the substrate.

Although the silkscreen process works to provide flexible circuitry, there are drawbacks. For example, the chemical waste that is generated from silkscreen processes requires disposal. Depending upon the types of inks and/or chemicals, special handling may be required for disposal. The silkscreen process is also a relatively expensive. Moreover, there is limited flexibility (in design) using silkscreen processes. Prototyping is difficult and, once a screen is made, it cannot be easily changed, if at all.

Alternative methods for fabricating conductive circuits have used inkjet printing technologies. However, in such a technology, the ink is formulated with conductive nano-particles and then printed with a modified inkjet printer. The printed circuits are sintered (heat treated) to fully fuse the conductive particles in the ink to achieve a continuous conductive pathway to create the circuit. Drawbacks to this method are the high cost of the conductive nano-particles, the difficulty formulating a jettable ink with desired end properties, special design features that are required for the inkjet printer to handle the conductive ink and the additional sintering step required for the “printed” circuit to achieve the desired conductivity.

Another alternative method for fabricating conductive circuits involves the use of a thermally printable electrically conductive ribbon. Such a ribbon includes a carrier web having first and second sides and an electrically conductive layer disposed on the first side of the carrier web. A portion of the electrically conductive layer is transferable to an associated object using a thermal transfer printer in order to form an electrically conductive circuit on the object. While the use of such a thermally printable electrically conductive ribbon provides numerous advantages over the prior art, the creation of highly complex and detailed circuits may be limited by the relatively low resolution of thermal transfer printers. Additionally, the speed to print such circuits using this method is limited because thermal transfer printers are relatively slow.

Accordingly, there is a need for a flexible electrically conductive circuit that is formed by a method that does not use a silkscreen process, a modified inkjet process or a thermal transfer printer process. Desirably, by this method, highly complex circuit designs may be created simply and quickly using common computer-aided circuit design tools. More desirably still, the method may use high speed, high resolution printing techniques, such as rotogravure or flexographic offset printing, to print the circuit design using a variety of common inks. Even more desirably, the method may use readily available, high resolution laser or inkjet printers to print the circuit design using a variety standard inks and toners. Most desirably, the method uses a hot lamination process to selectively transfer portions of a conductive layer of a film to the printed circuit design.

### BRIEF SUMMARY OF THE INVENTION

A method for printing electrically conductive circuits comprises the steps of providing a substrate, printing a circuit design on the substrate, providing a film having a conductive layer, selectively transferring portions of the conductive layer of the film to the printed circuit design on the substrate, optionally removing any remaining release coat and optionally applying a protective overcoat.

The present method produces electrically conductive circuits having a surprising level of print definition in a simple process. Using the present method, an electrical circuit is readily designed with computer-aided circuit design tools and the circuit design transferred to an object, advantageously and preferably, a flexible object, using common high resolution printing devices and techniques, such as inkjet printers, laser printers, rotogravure printing or flexographic offset printing, using standard inks and toners. The method uses a hot lamination process to selectively transfer portions of the conductive layer of the film to the printed circuit design in order to create the circuit.

These and other features and advantages of the present invention will be apparent from the following detailed description and drawings in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a plan view of an exemplary flexible circuit formed in accordance with the method of the present invention;

FIG. 2 is a cross-sectional view of a portion of the circuit of FIG. 1 taken along line 2-2 of FIG. 1; and

FIG. 3 is a perspective illustration of a preferred film used in the method of the present invention;

FIG. 4 is a cross-sectional view of the film of FIG. 3 taken along line 4-4;

FIG. 5 is a flow diagram illustrating the preferred method for fabricating the flexible circuit of FIG. 1; and,

FIG. 6 is an elevational view of an exemplary device using the method of the present invention.

### DETAILED DESCRIPTION OF THE INVENTION

While the present invention is susceptible of embodiment in various forms, there is shown in the figures and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description of the Invention,” relates to a requirement of the United States Patent Office, and does not imply, nor should be inferred to limit the subject matter disclosed herein.

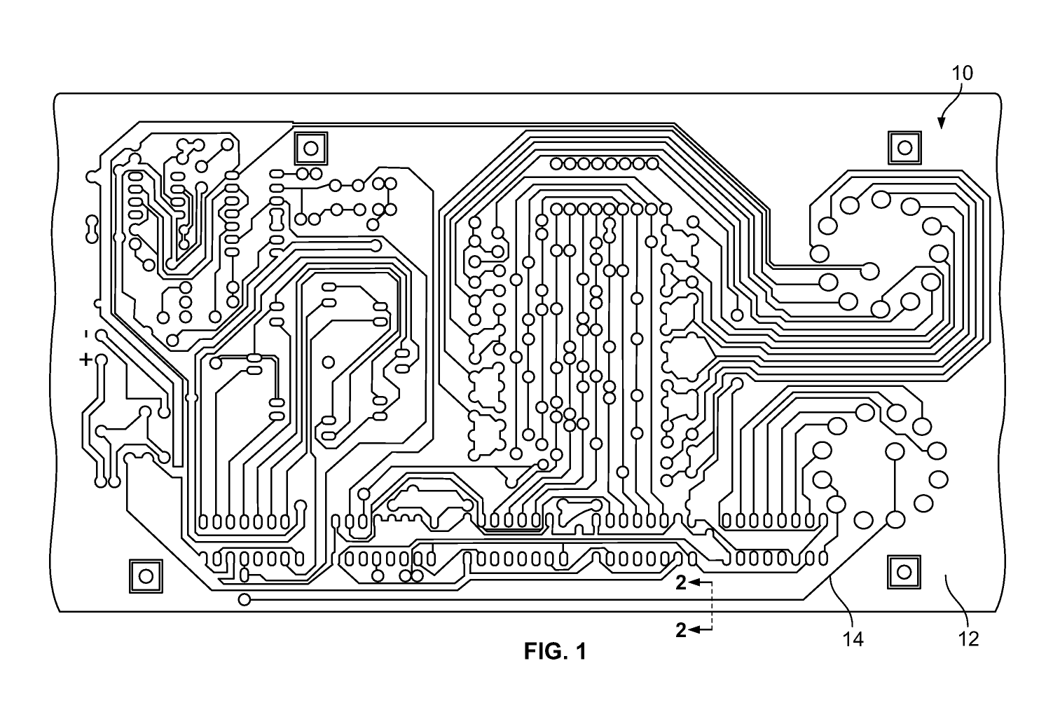

Referring to the FIG. 1, there is shown an exemplary flexible circuit 10 formed in accordance with the method of the present invention. Circuit 10 is formed from an electrically conductive material 14 on a flexible base film or substrate 12, such as mylar, acrylic, polyester film, vinyl film, paper, paper board or most any printable substrate. It will be appreciated that substrate 12 need not be a flexible medium. That is, it can be a rigid medium. However, the advantages of the present invention are well appreciated in a flexible substrate 12 environment. Such flexible circuits can, for example, be used in automobile dashboards, appliance control panels, aircraft backlit panels, computers and the like.

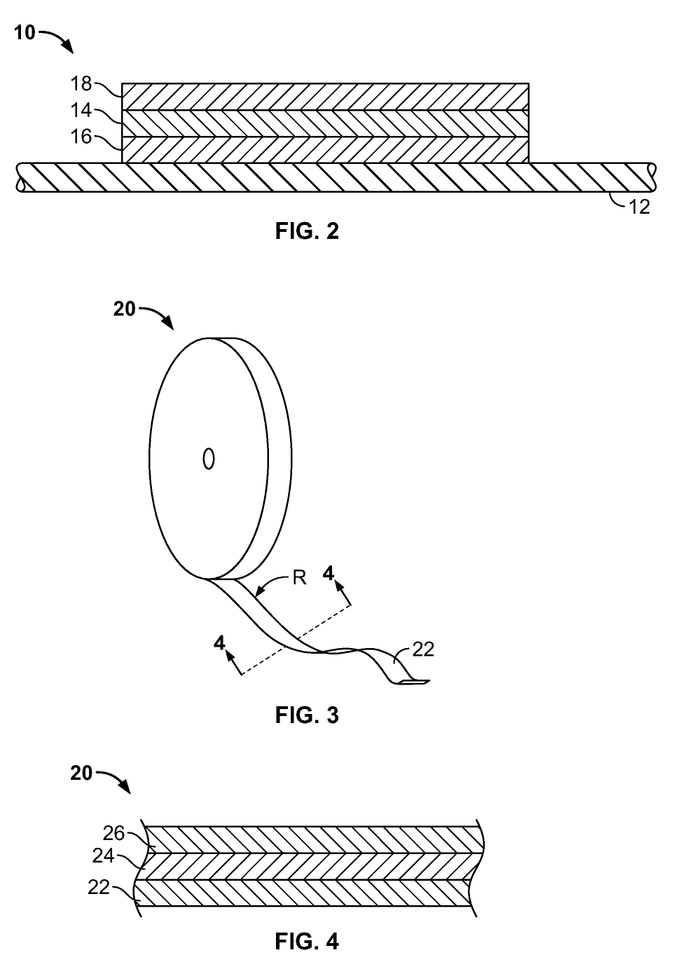

A cross-section of circuit 10 is illustrated in FIG. 2. Substrate 12 supports and provides structure for conductive material 14. Conductive material 14 is held to substrate 12 by an adhesive 16 that consists of the ink or toner printed on substrate 12 as the circuit design, as further discussed below. An optional protective coat 18 can be applied over conductive material 14.

A cross-section of a film 20 for use in transferring conductive material 14 to substrate 12 is illustrated in FIG. 4. In a preferred form, film 20 is formed as a ribbon R as seen in FIG. 3.

Referring to FIGS. 3 and 4, ribbon-formed film 20 includes a carrier web 22 and a release coat 24 formed on carrier web 22. A conductive layer 26 is applied to the release coat 24. The release coat 24 may remain on film 20 (i.e. with carrier 22) subsequent to transfer or may transfer along with conductive layer 26 to substrate 12.

Carrier web 22 can be formed from any of a wide variety of materials. One known material is a polyester film. A polyester film of about 4 to about 20 microns in thickness preferably is used for carrier web 22, but other gauges are possible. Those skilled in the art will recognize the other types and thicknesses of materials that may be used for carrier web 22.

Release coat 24 is formulated to respond to the heat and pressure applied to carrier web 22 during the hot lamination process to “release” conductive layer 26 from carrier web 22. One type of release coat 24 that releases with conductive layer 26 (transfers with conductive layer 26 to substrate 12) is an alkali-soluble thermoplastic polymer that is later removed from conductive layer 26 after conductive layer 26 is selectively transferred to substrate 12 to form conductive material 14.

Removing release coat 24 reduces the likelihood of interference with conductive layer 26. Release coat 24 can be removed with an alkaline solution such as an ammonia and water mixture. Other materials for release coat 24 that transfer with conductive layer 26 include various waxes such as paraffin, microcrystalline or polyethylene glycol. Modifiers such as cross-linking agents or coupling agents may be added to release coat 24 to improve performance.

Alternately, release coat 24 can be of the type that remains on carrier web 22 and does not transfer with conductive layer 26 to substrate 12. These types of coatings include, for example, cross-linked silicone based materials and the like. Modifiers can be included to facilitate release of conductive layer 26.

The electrically conductive layer 26 is applied to carrier web 22, over release coat 24. The layer 26 can be formed from a wide variety of metals, such as aluminum, copper, silver, gold, platinum, molybdenum, tungsten, titanium, tantalum, germanium, silicon and silicon-containing materials, indium tin oxide (ITO), aluminum tin oxide (ATO), aluminum zinc oxide (AZO), carbon, nickel and the like. Conductive layer 26 can be applied using processes such as spraying, coating, ion vapor deposition, vacuum metallization, sputter coating and the like. Those skilled in the art will recognize the various methods by which conductive layer 26 can be applied to or embedded into film 20.

Alternatively, it is contemplated that conductive layer 26 may be substituted by a coating, such as a resin, that is applied to carrier web 22. Such a coating would contain the same types of conductive materials found in conductive layer 26. In such cases, the coating may be formulated to release from carrier web 22 and transfer to substrate 12 during the hot roll lamination process, without the need for a release layer (such as release layer 24).

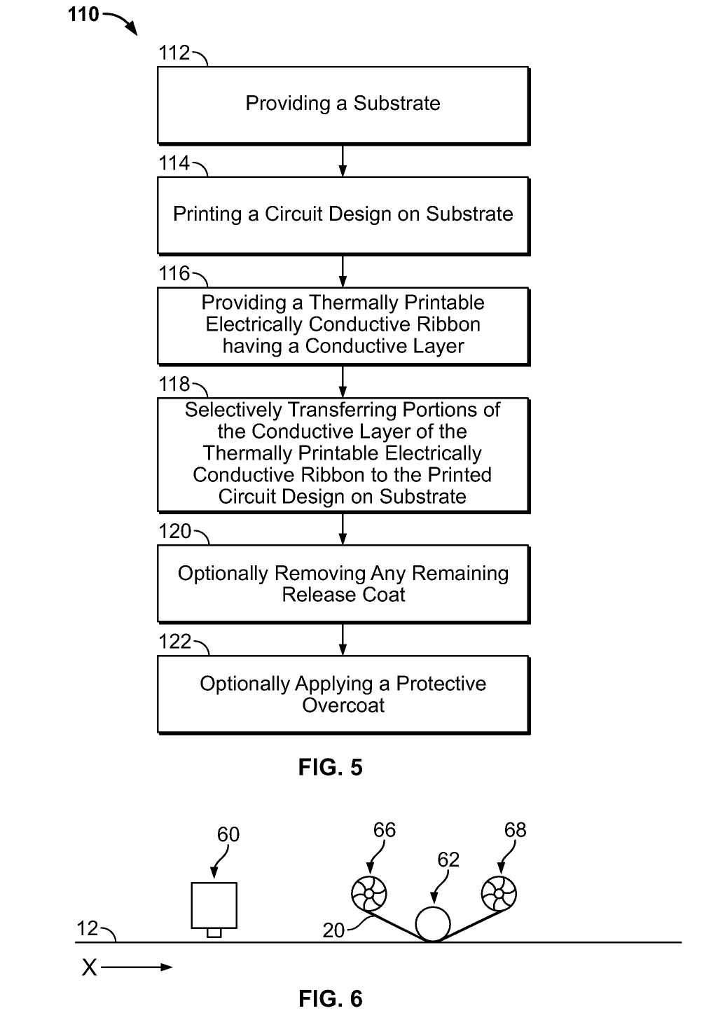

The preferred method 110 for fabricating flexible circuit 10 is illustrated in the flow diagram of FIG. 5. Method 110 comprises the steps of providing a substrate (12) 112, printing a circuit design on substrate (12) 114, providing a film 20 having a conductive layer (26) 116, selectively transferring portions of conductive layer 26 of film 20 to the printed circuit design on substrate (12) 118, optionally removing any remaining release coat (24) from the transferred portions of conductive layer (26) 120 and optionally applying a protective overcoat to circuit (10) 122.

The first step of preferred method 110 is to provide substrate 12. As discussed above, substrate 12 may be comprises of various materials, such as mylar, acrylic, polyester film, vinyl film, paper, paper board or most any printable substrate. Preferably, substrate 12 is a flexible materials, however, it will be appreciated that substrate 12 need not be flexible and may be rigid without departing from the scope of the present invention.

Next, a circuit design is printed on substrate 12 (114). In the preferred embodiment, the circuit design is printed on substrate 12 using common high resolution printing devices and techniques, such as inkjet printers, laser printers, rotogravure printing or flexographic offset printing, with standard inks and toners. Most inks and toners used with such devices and techniques include heat-activatable binder materials within their compositions. As known to those skilled in the prior art, such binder materials are designed to adhere to the surface being printed upon application of heat, thereby creating a desired printed design. Such inks and toners are preferred in the present invention since they not only adhere to substrate 12 when printed, but also adhere to conductive layer 26 of film 20 during the hot roll lamination process, as further discussed below.

At the next step, film 20 having a conductive layer 26 is provided 116. As discussed above, film 20 preferably is ribbon-formed (R) and is comprised of carrier web 22, release coat 24 formed on carrier web 22, and conductive layer 26 is formed on release coat 24.

Next, portions of conductive layer 26 are selectively transferred from film 20 to the circuit design printed on substrate (12) 118. In the preferred embodiment, this is accomplished using a hot laminating roll process as is known to those skilled in the art. In such a process, substrate 12 with the circuit design printed thereon is passed over (or under, depending on the embodiment) a hot laminating roller while in contact with conductive layer 26 of film 20. Preferably, as substrate 12 passes over the hot laminating roller with film 20, the hot laminating roller is in contact with the underside of carrier web 22 of film 20 and conductive layer 26 of film 20 is in contact with the circuit design printed on substrate 12.

In this step, the hot laminating roller exerts heat and pressure on carrier web 22 of film 20 and such heat and pressure are transferred through film 20 to the ink or toner printed on substrate 12 that comprise the circuit design. The heat from the hot laminating roller activates the heat-activatable binders contained in the ink or toner and cause the ink or toner to exhibit adhesive qualities and causes release layer 24 of film 20 either to release from carrier web 22 or to release conductive layer 26. In the preferred embodiment, the hot laminating roller temperature is set in the range of 200 to 400 degrees Fahrenheit, and more preferably in the range of 250 to 300 degrees Fahrenheit.

The pressure of the hot laminating roller (between 0 and 25 psi in the preferred embodiment) causes the portions of conductive layer 26 of film 20 that are in contact with the ink or toner to adhere to the ink or toner and release from film 20. Portions of conductive layer 26 of film 20 that are not in contact with the ink or toner are not transferred to substrate 12. Thus, the selective transfer of conductive layer 26 to substrate 12 (to form conductive material 14 of circuit 10) occurs only where the circuit design was printed and creates a circuit with the desired circuit design.

If necessary, any remaining release coat material is removed 120 from the now formed electrical circuit or portion of an electrical circuit 10. An optional protective coating (e.g., an over coating) can be applied 122 to the transferred electrical circuit 10.

One embodiment of a system utilizing the preferred method of the present invention is shown in FIG. 6. In this system, substrate 12 travels in direction X. A printer 60, which may be an inkjet printer or a laser printer using heat-activatable inks or toners consistent with the preferred method of the present invention, is disposed adjacent to the path of travel of substrate 12. As substrate 12 travels adjacent to printer 60, printer 60 prints the desired circuit design on substrate 12.

A hot lamination roller 62 is also disposed adjacent to the path of travel of substrate 12. Film 20, formed as a ribbon, is stored on supply reel 66 and travels along a path from supply reel 66, between hot lamination roller 62 and substrate 12, to take up reel 68.

As the circuit design printed on substrate 12 travels beneath film 20 and hot lamination roller 62, the heat of hot lamination roller 62 activates the heat-activatable ink or toner comprising the printed circuit design, causing the ink or toner to exhibit adhesive qualities. Additionally the heat of hot lamination roller 62 causes release layer 24 of film 20 either to release from carrier web 22 or to release conductive layer 26. The pressure exerted by hot lamination roller 62 causes the portions of conductive layer 26 of film 20 that are in contact with the ink or toner to adhere to the ink or toner and release from film 20. The portions of conductive layer 26 that are not in contact with the ink or toner are not transferred to substrate 12.

Thus, the selective transfer of conductive layer 26 to substrate 12 (to form conductive material 14 of circuit 10) occurs only where the circuit design was printed and creates a circuit with the desired circuit design.

One of the advantages of the present invention is that it allows the generation of circuits on a variety of substrates using a process that is simple and quick. Additionally, when the original image is generated using a laser or inkjet printer, all of the advantages of computer-generated digital printing are achieved, such as variable information capability. Multiple, diverse circuit designs may be successively printed and various circuits may be formed using a single production line.

When other printing techniques are used, such as rotogravure printing or flexographic offset printing, the ability to readily print variable circuit designs may be more limited, but the speed at which the circuit designs are printed may be advantageously increased.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover all such modifications as fall within the scope of the claims.

What is claimed is:

1. A method for creating an electrically conductive circuit, the method comprising the steps of:
providing a substrate;
printing a design of the circuit on the substrate;
providing a film having a conductive layer; and
selectively transferring the conductive layer to the substrate to form the circuit.

2. The method of creating an electrically conductive circuit of claim 1 wherein the film further comprises a carrier web on which the conductive layer is formed.

3. The method of creating an electrically conductive circuit of claim 2 wherein the film further comprises a release layer between the carrier web and the conductive layer.

4. The method of creating an electrically conductive circuit of claim 3 further comprising the step of removing any release coat from the selectively transferred conductive layer.

5. The method of creating an electrically conductive circuit of claim 1 further comprising the step of optionally applying a protective overcoat to the circuit.

6. The method of creating an electrically conductive circuit of claim 1 wherein the substrate is flexible.

7. The method of creating an electrically conductive circuit of claim 1 wherein the substrate is comprised of a material selected from the group consisting of mylar, acrylic, polyester film, vinyl film, paper and paper board.

8. The method of creating an electrically conductive circuit of claim 1 wherein the design of the circuit is printed using an inkjet printer.

9. The method of creating an electrically conductive circuit of claim 1 wherein the design of the circuit is printed using a laser printer.

10. The method of creating an electrically conductive circuit of claim 1 wherein the design of the circuit is printed by rotogravure printing.

11. The method of creating an electrically conductive circuit of claim 1 wherein the design of the circuit is printed by flexographic offset printing.

12. The method of creating an electrically conductive circuit of claim 1 wherein the design of the circuit is printed using a toner.

13. The method of creating an electrically conductive circuit of claim 12 wherein the toner comprises a heat-activatable binder.

14. The method of creating an electrically conductive circuit of claim 1 wherein the design of the circuit is printed using an ink.

15. The method of creating an electrically conductive circuit of claim 14 wherein the ink comprises a heat-activatable binder.

16. The method of creating an electrically conductive circuit of claim 1 wherein the conductive layer comprises at least one conductive material selected from the group consisting of aluminum, copper, silver, gold, platinum, molybdenum, tungsten, titanium, tantalum, germanium, silicon and silicon-containing materials, indium tin oxide (ITO), aluminum tin oxide (ATO), aluminum zinc oxide (AZO), carbon and nickel.

17. The method of creating an electrically conductive circuit of claim 1 wherein the step of selectively transferring the conductive layer to substrate to form the circuit comprises a hot roil lamination process.

18. The method of creating an electrically conductive circuit of claim 17 wherein the hot roll lamination process comprises the steps of:
providing a hot laminating roller;
printing the design of the circuit on the substrate using a toner;
transporting the film to the hot laminating roller;
transporting the substrate to the hot laminating roller;
positioning the film between the hot laminating roller and the substrate; and
using the hot laminating roller to exert heat and pressure on the film and the substrate, wherein the conductive layer of the film is selectively transferred from the film to the substrate by adhering to the toner.

19. The method of claim 18 wherein the toner comprises a heat-activatable binder.

20. The method of creating an electrically conductive circuit of claim 17 wherein the hot roll lamination process comprises the steps of:
providing a hot laminating roller;
printing the design of the circuit on the substrate using an ink;
transporting the film to the hot laminating roller;
transporting the substrate to the hot laminating roller;
positioning the film between the hot laminating roller and the substrate; and
using the hot laminating roller to exert heat and pressure on the film and the substrate, wherein the conductive layer of the film is selectively transferred from the film to the substrate by adhering to the ink.

21. The method of claim 20 wherein the ink comprises a heat-activatable binder.
